(19) United States
(12) Patent Application Publication
(10) Pub. No.: US 2004/0113405 A1
(43) Pub. Date: Jun. 17, 2004

(54) Gas bag module

(75) Inventors: Christian Stricker, Mainaschaff (DE); Michael Schneider, Sulzbach (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/731,075

(22) Filed: Dec. 9, 2003

(30) Foreign Application Priority Data
Dec. 12, 2002 (DE) 202 19 284.9

(51) Int. Cl. B60R 21/26

(52) U.S. Cl. 280/736

(57) ABSTRACT

A gas bag module for a vehicle occupant restraint device includes a gas generator and a diffusor which surrounds the gas generator and has a cup-shaped section. The diffusor cup-shaped section has a filter section consisting of a sintered porous material, through which the gas flows out from the gas generator. The porous material is selected from the group consisting of sintered metal powders, sintered metal fibers and metal foams.

### TECHNICAL FIELD

The invention relates to a gas bag module for a vehicle occupant restraint device.

### BACKGROUND OF THE INVENTION

A conventional gas bag module comprises a gas generator and a diffusor which surrounds the gas generator and has a cup-shaped section. The diffusor is a distinct component, separate from the generator.

Pyrotechnic gas generators usually have a filter device, in order to extract particles from the gas flowing out from the gas generator. By flowing through the filter, the temperature of the gas arriving into the gas bag is reduced. Therefore, a damage to the gas bag fabric is to be avoided. The filters are generally not designed to receive mechanical stresses.

DE 44 45 921 C1 discloses a gas generator with a gas generator housing made of a light alloy, a filtering insert being arranged in the housing. The housing may be manufactured in a die-casting method from a magnesium alloy. The filtering insert is configured as a fine pored filtering block which is permeable to gas and consists of a multiplicity of grains that are bonded to each other by a sintering process. The filtering block, however, has no supporting or load-receiving function. For the saving of weight, the diffusor housing surrounding the gas generator is likewise made in a die-casting method from a magnesium alloy.

It is an aim of the invention to provide a gas bag module which is favorably priced and is simply to manufacture.

### BRIEF SUMMARY OF THE INVENTION

According to the invention, a gas bag module comprises a gas generator and a diffusor which surrounds the gas generator and has a cup-shaped section. The cup-shaped section has a filter section consisting of a sintered porous material, through which the gas flows out from the gas generator. The porous material is selected from the group comprising sintered metal powders, sintered metal fibers and metal foams. In prior art, the diffusor consists of deep-drawn metal sheets or cast parts and always has outflow openings which are very large, so that no filtering function is provided. Therefore, particles released in the combustion of pyrotechnic material are not retained in the diffusor. The invention, in comparison, makes provision that the cup-shaped diffusor, which adjoins the outer housing of the gas generator and usually consists of a side wall and a cover as the cup-shaped section as well as a ring-shaped flange projecting outwards on the rim of the side wall lying opposite the cover, is used for cooling and filtering the gas. Therefore, in the interior of the gas generator, which has a closed outer housing, either only a small dimensioned filter or no filter at all has to be provided. The good filtering effect of the diffusor with, at the same time, a high mechanical loading capacity, is achieved in that the filter section consists of a sintered porous material which is selected from the group of sintered metal powders, metal fibers and metal foams.

The diffusor therefore takes over the function of a filter cage which, owing to its porous structure, makes possible the filtration of the hot particles emerging from the gas generator together with the gas stream. In addition, the diffusor also fulfils the functions of a bearing structural element, such as for example the receiving of mechanical stresses. The porosity of the diffusor or of the filter section preferably is to be designed such that the gas from the gas generator can flow unhindered through the filter section. In the arrangement, the pore size is, however, to be smaller than the particles which are ejected from the gas generator. The size, shape and distribution of the pores is variable and can be adapted to the respective case of application. Despite its low weight, the diffusor is temperature-resistant, gas-permeable and can be stressed mechanically.

According to a first and preferred embodiment, the entire cup-shaped section, preferably even the entire diffusor, consists of the sintered porous material, particularly preferably of sintered metal fibers.

According to a second embodiment, only the side wall of the cup-shaped section is produced from the sintered porous material, the cover and the side wall of the diffusor being connected with each other metallurgically.

The preferred embodiment makes provision that the entire diffusor is formed from the sintered porous material. It has been surprisingly found that such a material, e.g. of sintered metal fibers, despite its low density is sufficiently dimensionally stable to undertake the function of a gas bag carrier, for example, and at the same time can be highly stressed mechanically.

Hereby, several advantages present themselves. The number of components is reduced, because no carrier has to be additionally provided for the internal or external filter. At the same time, the weight and overall size of the gas bag module are reduced. A further advantage lies in that standard gas generators can be used, also on occasions in which, with a small amount of space available, an additional filtering of the gas is desired. Preferably, however, a gas generator can be used without associated particle filter in the gas generator housing. The omission of the particle filter leads on the one hand to a further saving with regard to weight and on the other hand to a simpler manufacture, because the working step of filter installation is also eliminated. Through the setting of a defined, finer porosity, in addition the possibility is provided for filtering out entirely the hot particles occurring on activation of the gas generator. Hereby, the risk of a burning through of the air bag fabric is prevented. Advantageously, uncoated gas bag fabrics can also be used, which leads to further savings with regard to weight, space and cost.

The cup-shaped section of the diffusor, surrounding the gas generator, can serve simultaneously as a spacer for the gas generator to the wall of the gas bag adjoining the diffusor.

The sintered porous material, in particular the sintered metal fibers, is designed such that it acts as a particle filter for gas flowing through, e.g. by the pore size or the wall thickness of the diffusor being appropriately selected. Here, it is particularly of advantage if the diffusor can be flowed through over a large area by gas flowing out from the gas generator into the gas bag, because an optimum filtering effect can thus be achieved.

The porous, sintered material can in addition provide for a uniform distribution of the gas emerging from the gas generator. Through the design of the filter material, the speed at which the gas flows into the gas bag can also be influenced, in order to carry out an adaptation of the restraint device to the requirement profile in question.

In an advantageous embodiment of the invention, the cup-shaped section of the diffusor is designed as a deformation element. For this, an upper side of the cup-shaped section is preferably spaced apart from the gas generator such that in the case of an impact of a vehicle occupant, a portion of the impact energy can be dissipated by the deformation of the diffusor. Through the design of the sintered metal fibers, the energy required for deformation can be determined in advance in relatively narrow limits, so that a flexible adaptation of the restraint device is possible.

In a preferred embodiment of the invention, the gas generator is mounted so as to be able to oscillate. The diffusor of the sintered porous material serves in this case as a so-called vibration attenuation cage, in which the gas generator, which acts as a damping mass for vibration attenuation, is mounted so as to be able to oscillate. As in such a case a gas bag carrier, separating the gas generator and gas bag wall, is absolutely necessary, a particularly great saving on space and weight can be achieved through the use of a diffusor of, for example, sintered metal fibers, without a loss in strength.

The production of the sintered porous material can take place by conventional methods of powder metallurgy. The production of porous filters from metal powders preferably takes place by means of cold isostatic forming methods. In so doing, connection elements, such as flanges and threaded pieces, or fastening elements can also be formed on in one operating step. Instead of metal powders, metal fibers can also be processed by the methods of powder metallurgy. The filters obtained therefrom are distinguished by a high porosity with a low flow resistance, a high filter fineness and dirt storage capacity. The metal fibers which are to be sintered are usually fleeced and are then processed further with or without supporting fabric by pressure sintering. It is also possible here to insert connecting or fastening elements into the unfinished product and to connect these elements metallurgically with the porous sintered shaped body by sintering.

The production of metal foams likewise is done by means of powder metallurgy methods, preferably with the addition of propellants, such as metal hydrides. The porosity can be set reproducibly here by means of the quantity of propellant and the sintering temperature and time.

### BRIEF DESCRIPTION OF THE DRAWINGS

FIG. 1 shows a perspective view of a diffusor of a gas bag module according to the invention;

FIG. 2 shows a diagrammatic sectional view of a gas bag module according to the invention, with the diffusor of FIG. 1;

FIG. 3 shows a perspective view of a further embodiment of the diffusor;

FIG. 4 shows a half section through the diffusor according to FIG. 3 along line IV-IV;

FIG. 5 shows a diagrammatic half sectional view of a third embodiment;

FIG. 6 shows a partial sectional view of the third embodiment according to FIG. 5; and

FIG. 7 shows a diagrammatic half sectional view of a fifth embodiment.

### DETAILED DESCRIPTION OF THE PREFERRED EMBODIMENTS

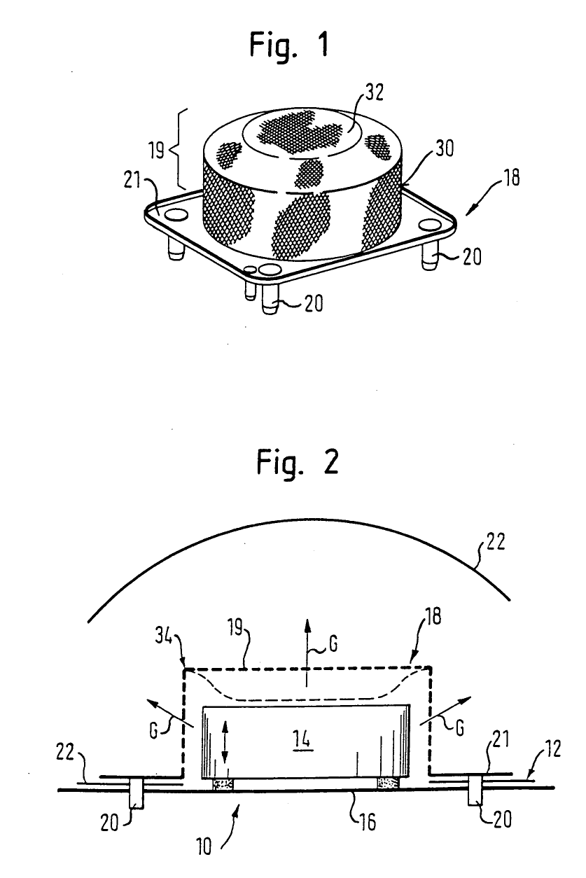

FIGS. 1 and 2 show a gas bag module 10 with a gas bag 12 shown in inflated state. A gas generator 14 is mounted so as to be oscillating and is connected with a part 16, e.g. a steering wheel, which is fixed to the vehicle. The gas generator is surrounded by a diffusor 18, a so-called vibration attenuation cage, which is illustrated in detail in FIG. 1. This vibration attenuation cage has a cup-shaped section 19 with a cylindrical side wall 30 and a cover 32. A ring-shaped flange 21 adjoins the edge of the side wall 30 opposite the cover 32. The diffusor 18 is fastened by means of pins 20 which engage on the flange 21, to the part 16, which is fixed to the vehicle. The edge of an inflow opening of the gas bag 12 is clamped between the flange of the diffusor and the part 16 which is fixed to the vehicle.

The diffusor 18 is arranged between the gas generator 14 and the wall 22 of the gas bag 12. In the folded state, the gas bag 12 lies on the upper side of the cup-shaped section 19. The wall 22 of the gas bag 12 can therefore not come in direct contact at any point with the gas generator 14, which is hot in the operating state. The gas generator 14 is arranged spaced apart from the diffusor 18 so that it can maintain its function as an oscillation attenuation means unimpeded inside the diffusor 18.

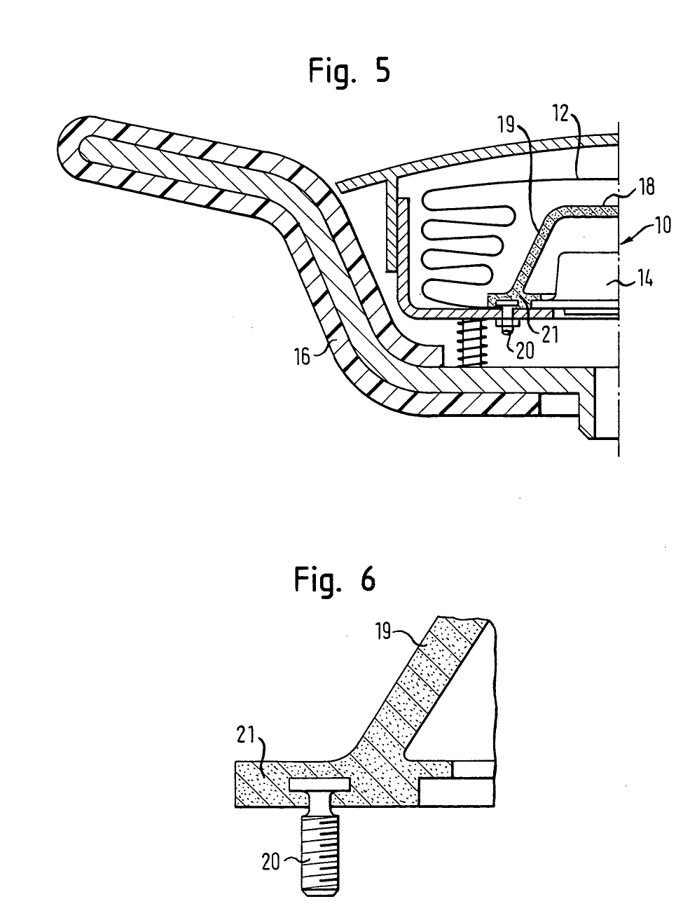

At least the cup-shaped section 19 of the diffusor 18 consists of a structurally stable sintered porous material. The material can be a sintered metal powder, a shaped body of sintered metal fibers or a metal foam. In the embodiment according to FIG. 1, the entire cup-shaped section 19 is formed from sintered porous material and gas G can arrive into the interior of the gas bag 22 through the entire cup-shaped section 19, so that the entire cup-shaped section 19 forms a filter section 34. The porosity of the sintered metal fibers is set such that particles which are contained in the gas G flowing out from the gas generator 14, are filtered out. No further component, such as for instance a gas bag carrier consisting of sheet metal, is provided between the gas generator 14 and the gas bag wall 22. Also, the flange 21 can consist of sintered metal fibers, as shown in FIGS. 5 and 6.

In addition to the function as vibration attenuation cage and as particle filter, the diffusor 18 in the example shown here serves in addition as a deformation element, in order for example to damp the impact of a part of the vehicle occupant's body. The sintered porous material of the cup-shaped section 19 deforms, as indicated by the dotted line in FIG. 2, on impact of a body part and thus decreases its energy in order to protect the vehicle occupant from injuries.

The diffusor 18 which is shown here can of course also be used together with a gas generator which is not mounted so as to be able to oscillate.

With a corresponding design of the diffusor with regard to porosity, capability of being flowed through and filter fineness, so that the hot particles generated by the gas generator are held back completely, the gas generator no longer has to have a filter, because this function is then completely fulfilled by the diffusor.

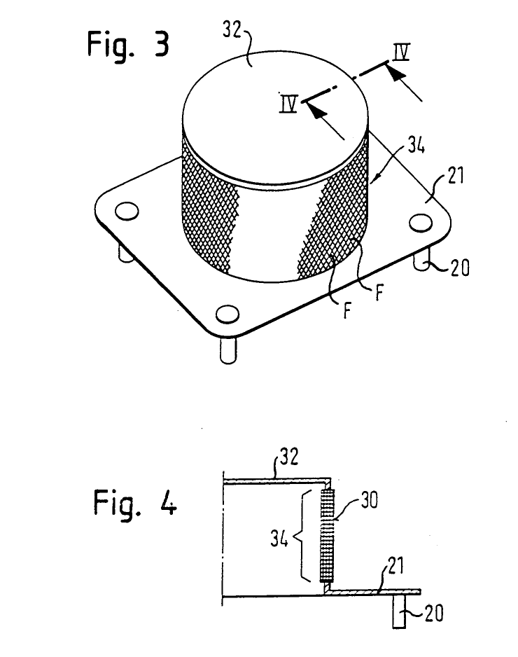

In the embodiment according to FIGS. 3 and 4, the flange 21 and the cover 32 are made of sheet metal. Almost the entire side wall 30 (except for only a short cross-piece on the cover 32 and on the flange 21) is formed by the filter section 34, which is produced from sintered porous material. In the actual case according to FIG. 3, this is a shaped body of sintered metal fibers. The filter section is closed peripherally and represents the single bridge between the cover 32 and the flange 21, is therefore arranged so as to be load-bearing between these sections and is formed onto the flange 21 or onto the cover 32 by a sintering process.

In the embodiment shown in FIGS. 5 and 6, the diffusor 18 is produced entirely from the sintered porous material. A fastening element 20, here a pin with a screw thread, is embedded in the flange 21 and is connected metallurgically with the sintered porous material. Alternatively to this, provision can be made to form an opening in the flange 21 and to pass the fastening element 20 through, in a similar manner to that as this illustrated in FIG. 1. By means of the fastening element 20, the diffusor 18 is firmly connected with a carrier for the gas generator 14, which is mounted so as to be able to oscillate and is arranged on a part 16 of the vehicle, here a steering wheel fixed to the vehicle. The gas bag 12 is clamped at its inflow opening between the flange 21 and the gas generator carrier and is additionally held by the fastening element 20. In the embodiment shown here, the gas bag 12 is folded in a conventional manner over the diffusor 18.

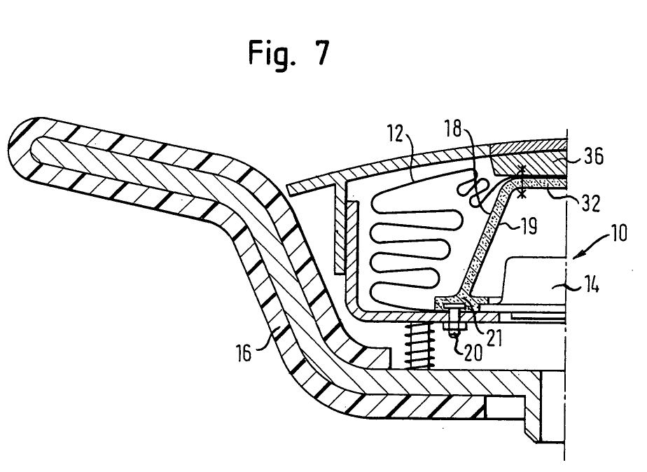

In a further embodiment shown in FIG. 7, provision can be made that the gas bag 12 surrounds the diffusor 18 in a ring shape and is clamped at its edge both between the flange 21 and the gas generator carrier and also between the cover 32 of the diffusor 18 and a mounting 36. Otherwise, identical reference numbers in the figures designate identical components having the same function.

1. A gas bag module for a vehicle occupant restraint device, said gas bag module comprising a gas generator and a diffusor wherein the diffusor has a cup-shaped section, surrounding said gas generator, and wherein said cup-shaped section has a gas-permeable filter section consisting of a sintered porous material, said porous material being selected from the group consisting of sintered metal powders, sintered metal fibers and metal foams.

2. The gas bag module according to claim 1, in which said filter section is designed such that it acts as a particle filter for gas (G) flowing therethrough.

3. The gas bag module according to claim 1, wherein said filter section consists of sintered metal fibers with a porosity of 85-95%.

4. The gas bag module according to claim 1, wherein said cup-shaped section comprises a side wall and a cover, said side wall being formed from said sintered porous material.

5. The gas bag module according to claim 1, wherein that said cup-shaped section consists of said sintered porous material.

6. The gas bag module according to claim 1, in which said cup-shaped section is designed as a deformation element.

7. The gas bag module according to claim 1, in which said gas generator is mounted so as to be able to oscillate.

8. The gas bag module according to claim 1, wherein that said cup-shaped section has a rim with a laterally projecting ring-shaped flange provided thereon, which likewise consists of said sintered porous material, at least one fastening element being embedded in said flange and being connected metallurgically with said sintered porous material.

9. The gas bag module according to claim 1, wherein said gas generator is realized without any filter within said gas generator.
